(19) United States
(12) Patent Application Publication
(10) Pub. No.: US 2026/0098568 A1
(43) Pub. Date: Apr. 9, 2026

(54) DISC BRAKE DEVICE

(71) Applicant: SUBARU CORPORATION, Tokyo (JP)

(72) Inventors: Kazuma SAITO, Tokyo (JP); Yasufumi SUZUKI, Tokyo (JP); Takashi MIMURA, Tokyo (JP); Hikaru FUSHIMI, Tokyo (JP)

(73) Assignee: SUBARU CORPORATION, Tokyo (JP)

(21) Appl. No.: 19/333,935

(22) Filed: Sep. 19, 2025

(30) Foreign Application Priority Data
Sep. 25, 2024 (JP) 2024-165888

(51) Int. Cl. F16D 55/2265; F16D 55/00; F16D 65/095; F16D 65/18

(52) U.S. Cl. CPC F16D 55/2265; F16D 65/095; F16D 65/18; F16D 2055/0016

(57) ABSTRACT

A disc brake device includes a rotor, a caliper body disposed near the rotor, a first pad disposed facing the rotor on a first side, a second pad disposed facing the rotor on a second side, a piston that pushes the second pad toward the rotor, a slide pin fixed to the caliper body, a support bracket having an insertion hole in which the slide pin is placed, and a covering member having a pleat and covering a portion of the slide pin that is exposed outside the insertion hole. An internal space defined by the insertion hole and the covering member includes a first internal space provided in the pleat, and a second internal space obtained by excluding the first internal space from the internal space. A volume ratio of the first internal space to the second internal space is set within a predetermined range.

### CROSS-REFERENCE TO RELATED APPLICATIONS

The present application claims priority from Japanese Patent Application No. 2024-165888 filed on Sep. 25, 2024, the entire contents of which are hereby incorporated by reference.

### BACKGROUND OF THE INVENTION

### Field of the Invention

The disclosure relates to a disc brake device.

### Description of Background Art

Japanese Unexamined Patent Application Publication (JP-A) No. H11-287267 describes a disc brake device. The entire contents of this publication are incorporated herein by reference.

### SUMMARY OF THE INVENTION

According to one aspect of the present invention, a disc brake device includes a rotor, a caliper body, a slide pin fixed to the caliper body, a support bracket having an insertion hole that place the slide pin, and a covering member having a pleat and covering a portion of the slide pin exposed outside the insertion hole of the support bracket, a first pad fixed to the caliper body and positioned to face the rotor on a first side of the rotor, a second pad positioned to face the rotor on a second side of the rotor, and a piston that pushes the second pad toward the rotor. The insertion hole of the support bracket and the covering member enclosing the portion of the slide pin form an internal space such that the internal space includes a first internal space in the pleat of the covering member and a second internal space excluding the first internal space from the internal space and that a ratio of a first volume of the first internal space to a second volume of the second internal space is set within a predetermined range.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a sectional view of a disc brake device according to an embodiment of the disclosure;

FIG. 2A is a sectional view of a slide pin and a support bracket that are included in the disc brake device according to the embodiment of the disclosure;

FIG. 2B is a sectional view of an internal space provided in the disc brake device according to the embodiment of the disclosure;

FIG. 3A is a sectional view of the disc brake device according to the embodiment of the disclosure and illustrates a state of operation thereof;

FIG. 3B is a sectional view of the disc brake device according to the embodiment of the disclosure and illustrates another state of operation thereof;

FIG. 4 is a graph illustrating a relationship established in the disc brake device according to the embodiment of the disclosure among the pull-out amount of the slide pin, the volumes of the internal space and individual spaces, and the ratio of a first volume to a second volume;

FIG. 5 is a graph illustrating a relationship established in the disc brake device according to the embodiment of the disclosure among the pull-out amount of the slide pin, the volumes of the internal space and individual spaces, and the ratio of the first volume to the second volume, with the number of pleats produced in a covering member changed; and

FIG. 6 is a graph illustrating a relationship established in the disc brake device according to the embodiment of the disclosure among the pull-out amount of the slide pin, the volumes of the internal space and individual spaces, and the ratio of the first volume to the second volume, with the diameter of a pin shaft changed.

### DETAILED DESCRIPTION OF THE EMBODIMENTS

Embodiments will now be described with reference to the accompanying drawings, wherein like reference numerals designate corresponding or identical elements throughout the various drawings.

The following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. In the following description, directions are defined by using terms such as top, bottom, left, and right.

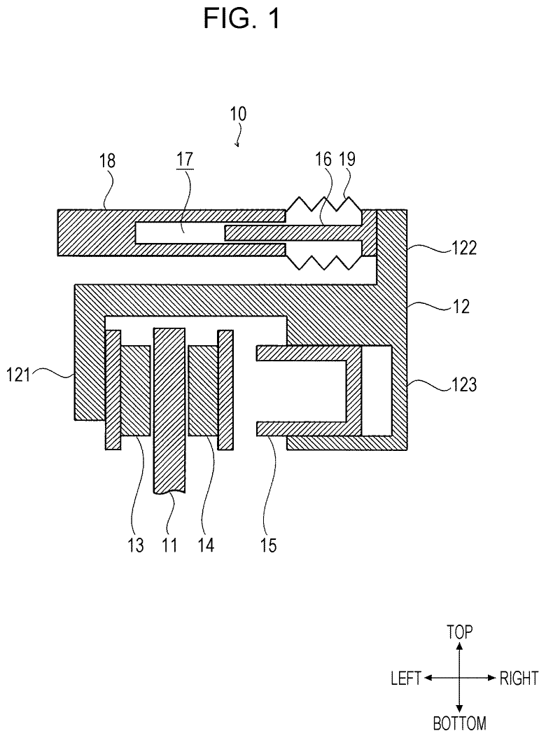

FIG. 1 is a sectional view of a disc brake device 10 according to an embodiment of the disclosure. The disc brake device 10 basically includes a rotor 11, a caliper body 12, a first pad 13, a second pad 14, a piston 15, a slide pin 16, a support bracket 18, and a covering member 19. The disc brake device 10 is included in a vehicle, for example, a passenger car. The disc brake device 10 is a component of a vehicle that is configured to brake to decelerate or stop the vehicle when an occupant of the vehicle depresses a brake pedal.

The rotor 11 is a metal plate formed in a substantially disc shape. The rotor 11 rotates together with a tire (not illustrated). Therefore, sandwiching the rotor 11 between the first pad 13 and the second pad 14 limits the rotations of the rotor 11 and the tire and thus brakes the vehicle. As to be described below, the rotor 11 has a manufacturing error and a mounting error that are predetermined. Therefore, while the rotor 11 is rotating, the rotor 11 tends to run out in the left-right direction. Such a phenomenon is referred to as face runout of the rotor 11.

The caliper body 12 is disposed near the rotor 11 and constitutes the body of the disc brake device 10. The caliper body 12 is a single piece of metal that is obtained by casting, cutting, or the like. The caliper body 12 includes a claw 121, a pin support 122, and a piston housing 123. The claw 121 constitutes a claw-shaped portion located on the left side in the disc brake device 10. The claw 121 supports the first pad 13. The pin support 122 constitutes an upper-right portion of the disc brake device 10 and supports the slide pin 16. The piston housing 123 has a hollow and constitutes a lower-right portion of the disc brake device 10. The piston housing 123 houses the piston 15 while allowing the piston 15 to slide.

The first pad 13 is disposed facing the rotor 11 on the left side of the rotor 11. The left side is defined as a first side. The first pad 13 is fixed to the claw 121 of the caliper body 12.

The second pad 14 is disposed facing the rotor 11 on the right side of the rotor 11. The right side is defined as a second side. The second pad 14 is movable in the left-right direction. As to be described below, when the second pad 14 is pushed by the piston 15, the second pad 14 presses the rotor 11 from the right side.

The piston 15 is configured to push the second pad 14 toward the rotor 11. The piston 15 is housed in the piston housing 123 of the caliper body 12 while being allowed to slide in the left-right direction.

The slide pin 16 is fixed to the caliper body 12. For example, the slide pin 16 is fixed to the left side face of the pin support 122. The pin support 122 has a substantially circular columnar shape, with the center axis thereof extending in the left-right direction.

The support bracket 18 has an insertion hole 17, in which the slide pin 16 is placed. The support bracket 18 is separate from the caliper body 12 and is fixed to a vehicle body of a vehicle (not illustrated).

The insertion hole 17 has a substantially circular columnar shape and opens to the right side of the support bracket 18. The insertion hole 17 has a greater size than the slide pin 16. A left portion of the slide pin 16 is accommodated in a right portion of the insertion hole 17. While the disc brake device 10 is in operation, the slide pin 16 moves back and forth inside the insertion hole 17.

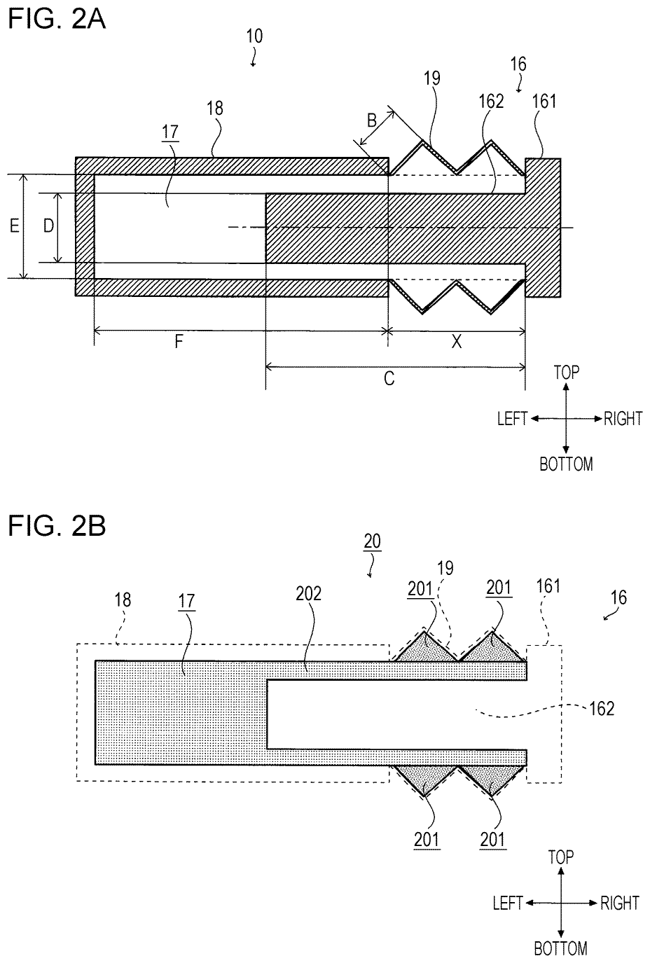

The covering member 19 has a pleated shape and covers a portion of the slide pin 16 that is exposed outside the insertion hole 17. The left end of the covering member 19 is coupled to the support bracket 18 and is thus sealed. The right end of the covering member 19 is coupled to the pin support 122 or the slide pin 16 and is thus sealed. As to be described below, the covering member 19 defines a space in which the slide pin 16 is enclosed. Details of the space will be described separately below with reference to FIGS. 2A and 2B and others. The shape of the covering member 19 is set such that the movement of the slide pin 16 changes the volume of an internal space 20 by a small amount. The covering member 19 provides a sealed space for accommodating the slide pin 16 so that dust is less likely to enter the sealed space from the outside. The covering member 19 is also referred to as a dust boot.

FIG. 2A is a sectional view of the slide pin 16 and the support bracket 18 of the disc brake device 10. FIG. 2B is a sectional view of the internal space 20.

Referring to FIG. 2A, the support bracket 18 has a substantially cylindrical outer shape. The insertion hole 17, which is a bottomed hole provided in the support bracket 18, also has a substantially cylindrical shape. The slide pin 16 includes a pin head 161 and a pin shaft 162. The pin head 161 is fixed to the above-described pin support 122. A left portion of the pin shaft 162 is placed in the insertion hole 17 provided in the support bracket 18. In FIG. 2A, the center axis of the substantially cylindrical elements is represented by a one-dot chain line.

In FIG. 2B, the internal space 20 is hatched. In FIG. 2B, elements other than the internal space 20 are illustrated by dotted lines.

The internal space 20 is a closed space defined by the insertion hole 17 and the covering member 19 that enclose the slide pin 16. The internal space 20 includes first internal spaces 201 and a second internal space 202.

The first internal spaces 201 are provided in the respective pleats of the covering member 19. The shape of the first internal spaces 201 changes in the top-bottom direction and in the left-right direction with the movement of the slide pin 16 in the left-right direction. As to be described below, the volume of the first internal spaces 201 changes nonlinearly with the movement of the slide pin 16 in the left-right direction. That is, as the pull-out amount, to be described below, of the slide pin 16 increases, the volume of the first internal spaces 201 increases and/or decreases depending on the situation. In FIG. 2B, the first internal spaces 201 are hatched with dense dots.

The second internal space 202 is a space obtained by excluding the first internal spaces 201 from the internal space 20. In other words, the second internal space 202 is a total space provided in the insertion hole 17 and an extension of the insertion hole 17 to the left face of the pin head 161, with the space occupied by the pin shaft 162 excluded. As to be described below, the volume of the second internal space 202 changes linearly with the movement of the slide pin 16 in the left-right direction. That is, as the pull-out amount, to be described below, of the slide pin 16 increases, the volume of the second internal space 202 increases. In FIG. 2B, the second internal space 202 is hatched with sparse dots.

In the present embodiment, as to be described below, the ratio of a first volume V201, which is the total volume of the first internal spaces 201, to a second volume V202, which is the volume of the second internal space 202, is set within a predetermined range. Such a setting lessens the sharpness of the change in the volume of the internal space 20 that is caused by the back-and-forth movement of the slide pin 16, and thus reduces the drag resistance at the rotor 11.

The movable amount, S, of the slide pin 16 is calculable by Math. 1 below.

$$S = P + R$$

In Math. 1, P denotes the wear amount of the first pad 13 or the second pad 14, and R denotes the runout amount of the rotor 11.

The first volume V201 of the first internal spaces 201 is calculable by Math. 2 below.

$$V 201 = \frac{8 π {x ( \sqrt{{B}^{2} - \frac{{x}^{2}}{4 {n}^{2}}} + \frac{E}{2} )}^{3} - π {xE}^{3} - 6 π {xE}^{2} \sqrt{{B}^{2} - \frac{{x}^{2}}{4 {n}^{2}}}}{48 n \sqrt{{B}^{2} - \frac{{x}^{2}}{4 {n}^{2}}}}$$

The second volume V202 of the second internal space 202 is calculable by Math. 3 below.

$$V 202 = π ( \frac{{E}^{2} F + {E}^{2} x - {D}^{2} C}{4} )$$

Referring to FIG. 2A, the parameters included in Maths. 2 and 3 given above are as follows. B denotes the length of each oblique side of the covering member 19, C denotes the length of the pin shaft 162, D denotes the diameter of the pin shaft 162, E denotes the diameter of the insertion hole 17, F denotes the depth of the insertion hole 17, X denotes the pull-out amount of the pin shaft 162, and n denotes the number of pleats in the covering member 19.

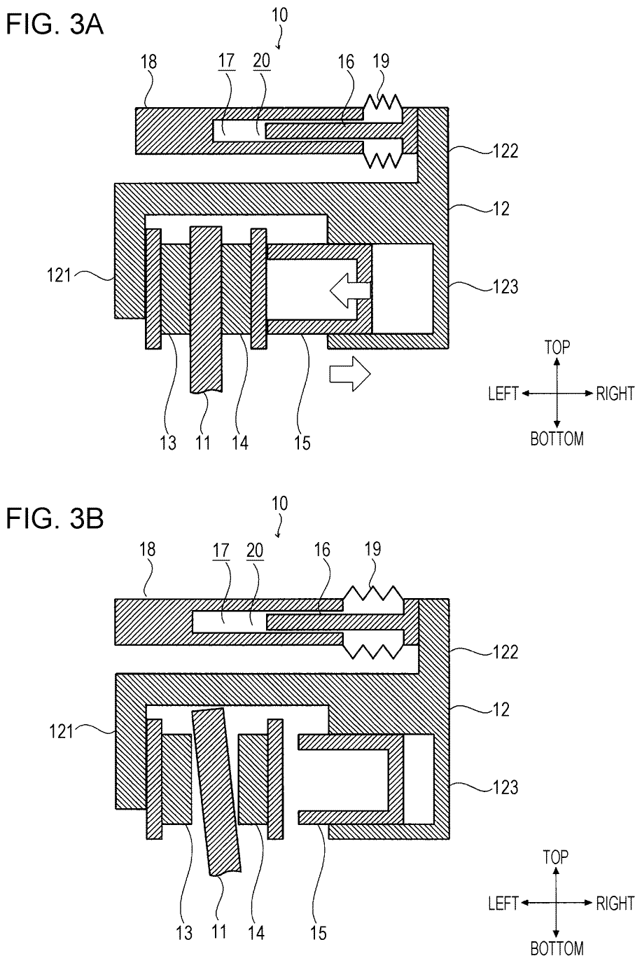

FIG. 3A is a sectional view of the disc brake device 10 and illustrates a state of operation thereof. When an occupant (not illustrated) depresses the brake pedal, the inside of the piston housing 123 is pressurized, which moves the piston 15 leftward. Accordingly, the second pad 14 is pressed against the right side face of the rotor 11. The pressing generates a reaction force that causes the caliper body 12 to slide rightward. Accordingly, the first pad 13 is pressed against the left side face of the rotor 11. Thus, the first pad 13 and the second pad 14 press the rotor 11 from the left side and the right side, respectively, whereby the rotation of the rotor 11 is limited. Consequently, the rotation of the tire coupled to the rotor 11 is limited, which applies a braking force to the vehicle and decelerates or stops the vehicle. In such an operation, the slide pin 16 moves in the left-right direction together with the caliper body 12. On the other hand, the support bracket 18, which is separate from the caliper body 12 and is attached to the vehicle body, does not move with the operation of the disc brake device 10.

FIG. 3B is a sectional view of the disc brake device 10 and illustrates a subsequent state of operation thereof. When the occupant (not illustrated) releases his/her foot from the brake pedal, the pressure in the piston housing 123 is reduced, whereby the pushing force applied to the second pad 14 by the piston 15 is removed. The rotor 11 has a manufacturing tolerance and an assembly tolerance that are predetermined. Therefore, when the restraint by the first pad 13 and the second pad 14 is removed, the rotor 11 tends to undergo face runout in which the rotor 11 rotates while running out in the left-right direction. If face runout occurs in the disc brake device 10, the rotor 11 pushes the first pad 13 leftward and pushes the second pad 14 rightward. Accordingly, the caliper body 12 and the slide pin 16 move in the left-right direction. On the other hand, the support bracket 18, which is fixed to the vehicle body, is not displaced with the face runout of the rotor 11. That is, the occurrence of face runout of the rotor 11 causes the slide pin 16 to slide relative to the support bracket 18 and also causes the covering member 19 to repeat contraction and expansion, whereby the volume of the internal space 20 changes. Consequently, a great drag resistance may be generated at the rotor 11. In the present embodiment, the volume ratio of the first internal spaces 201 to the second internal space 202 is set within a predetermined range, whereby the change in the volume of the internal space 20 is reduced so that the resistance at the rotor 11 is reduced. Thus, the fuel efficiency of the vehicle is improved.

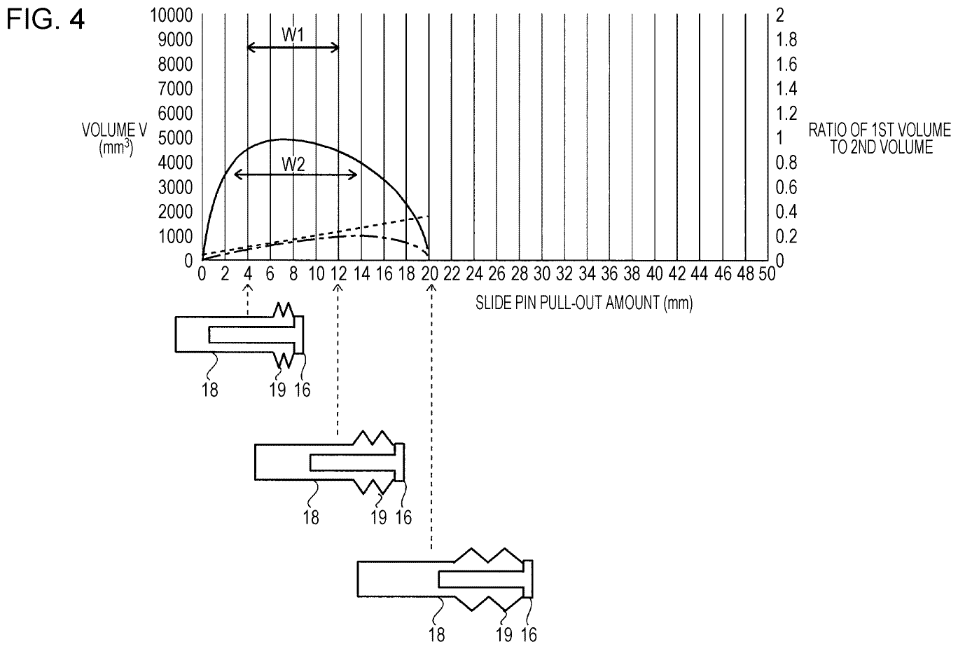

Referring now to FIGS. 4, 5, and 6, relationships established in the disc brake device 10 among the pull-out amount of the slide pin 16, the volumes of the internal space 20 and individual spaces, and the ratio of the first volume V201 to the second volume V202 will now be described. In FIGS. 4, 5, and 6, the horizontal axis represents the pull-out amount X (see FIG. 2A) of the pin shaft 162, the left vertical axis represents the volume, and the right vertical axis represents the ratio of the first volume V201 to the second volume V202. The second volume V202 is the volume of the second internal space 202, and the first volume V201 is the total volume of the first internal spaces 201.

FIG. 4 is based on the following conditions: the length B of each oblique side of the covering member 19 is 5 mm, the length C of the pin shaft 162 is 51.2 mm, the diameter D of the pin shaft 162 is 9.9 mm, the diameter E of the insertion hole 17 is 10 mm, the depth F of the insertion hole 17 is 52 mm, the number n of pleats in the covering member 19 is 2, the wear amount P of the first pad 13 or the second pad 14 is 8 mm, and the runout amount R of the rotor 11 is 0.1 mm. In FIG. 4, different states of the covering member 19 that correspond to different pull-out amounts of the pin shaft 162 are illustrated below the graph.

In the graph illustrated in FIG. 4, a domain W1 represents the movable amount of the slide pin 16. Furthermore, a domain W2 represents a domain in which the ratio of the first volume V201 to the second volume V202 is 0.8 or greater and 1.2 or smaller.

In the graph illustrated in FIG. 4, the first volume V201 is illustrated by a one-dot chain line, and the second volume V202 is illustrated by a dotted line. Furthermore, the ratio of the first volume V201 to the second volume V202, that is, a value obtained by dividing the first volume V201 by the second volume V202, is illustrated by a solid line. As is obvious from the graph, the first volume V201 illustrated by the one-dot chain line increases together with the pull-out amount of the slide pin 16 until the pull-out amount of the slide pin 16 reaches a value about 14 mm, but decreases when the pull-out amount of the slide pin 16 exceeds the value about 14 mm. On the other hand, the second volume V202 illustrated by the dotted line positively correlates with the pull-out amount of the slide pin 16.

In the domain W2, the change in the second volume V202 is absorbed by the change in the first volume V201. Therefore, referring to FIG. 3B, even if the face runout of the rotor 11 causes the slide pin 16 to move inside the insertion hole 17, the volume of the internal space 20 illustrated in FIG. 2B is less likely to change. Accordingly, the pressure in the internal space 20 is less likely to fluctuate, and the movement of the slide pin 16 is less likely to be hindered. Therefore, the resistance occurring in the disc brake device 10 is reduced. Consequently, the fuel consumption of the vehicle is reduced.

In the case illustrated in FIG. 4, the domain W1 is defined within the domain W2. Such a setting realizes the above-described range of the ratio over the entire domain in which the slide pin 16 is movable, and thus reduces the pressure fluctuation in the internal space 20.

The ratio of the first volume V201 to the second volume V202 may preferably be 0.9 or greater and 1.1 or smaller, more preferably 0.95 or greater and 1.05 or smaller. If the ratio is within such a range, the above-described effects are pronounced.

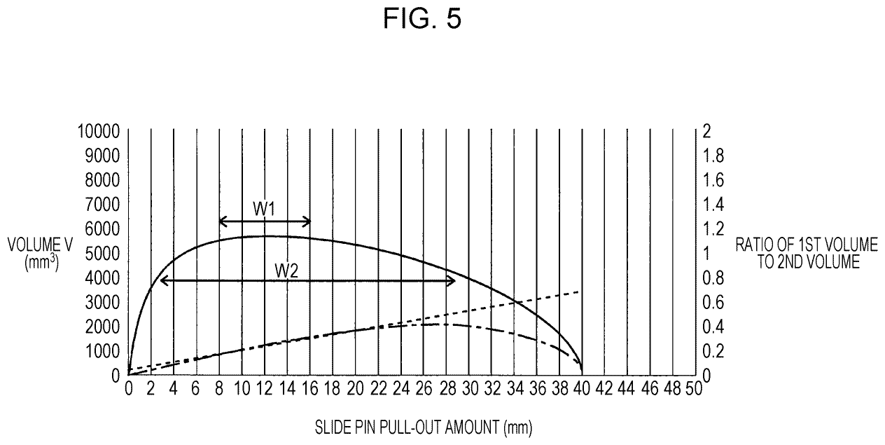

In FIG. 5, the horizontal axis and the two vertical axes are the same as in FIG. 4. FIG. 5 is based on the same conditions as FIG. 4, except that the number n of pleats in the covering member 19 is changed to 4.

Since the number n of pleats in the covering member 19 is increased, the domain W2 in which the ratio of the first volume V201 to the second volume V202 is 0.8 or greater and 1.2 or smaller is widened. In such a case, the above-described domain W1 is allowed to be widened.

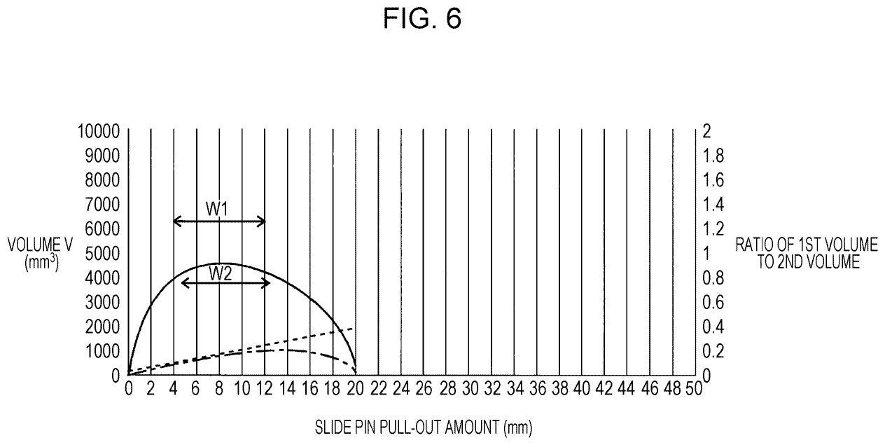

In FIG. 6, the horizontal axis and the two vertical axes are the same as in FIG. 4. FIG. 6 is based on the same conditions as FIG. 4, except that the diameter D of the pin shaft 162 is reduced to 9.8 mm.

Since the diameter D of the pin shaft 162 is reduced, the domain W2 in which the ratio of the first volume V201 to the second volume V202 is 0.8 or greater and 1.2 or smaller is narrowed. In such a case, if the dimensions of the elements constituting the disc brake device 10 are reviewed such that the domain W1 is defined within the domain W2, the pressure fluctuation in the internal space 20 is reduced.

A disc brake device according to an embodiment of the disclosure includes a rotor; a caliper body disposed near the rotor; a first pad disposed facing the rotor on a first side of the rotor and fixed to the caliper body; a second pad disposed facing the rotor on a second side of the rotor; a piston that pushes the second pad toward the rotor; a slide pin fixed to the caliper body; a support bracket having an insertion hole in which the slide pin is placed; and a covering member having a pleat and covering a portion of the slide pin, the portion being exposed outside the insertion hole. A space defined by the insertion hole and the covering member that enclose the slide pin serves as an internal space. The internal space includes a first internal space provided in the pleat of the covering member, and a second internal space obtained by excluding the first internal space from the internal space. A ratio of a first volume that is a volume of the first internal space to a second volume that is a volume of the second internal space is set within a predetermined range. The disc brake device provided according to the above embodiment of the disclosure exhibits reduced pressure fluctuation inside the covering member while the disc brake device is in operation, which reduces the drag resistance occurring in the disc brake device and consequently improves the energy efficiency of a vehicle including the disc brake device during the travel of the vehicle.

In the disc brake device according to the above embodiment of the disclosure, the ratio of the first volume to the second volume may be 0.8 or greater and 1.2 or smaller. In the disc brake device according to the above embodiment of the disclosure, setting the ratio of the first volume to the second volume within the above range enhances the effect of reducing the pressure fluctuation inside the covering member and thus reducing the drag resistance occurring in the disc brake device.

In the disc brake device according to the above embodiment of the disclosure, the ratio of the first volume to the second volume may be set within a predetermined range in a domain that represents a movable amount of the slide pin. In the disc brake device according to the above embodiment of the disclosure, the volume of the internal space is less likely to change in the domain that represents the movable amount of the slide pin. Therefore, the resistance occurring in the disc brake device is reduced.

While an embodiment of the disclosure has been described above, the disclosure is not limited thereto, and modifications can be made thereto without departing from the scope of the disclosure. Moreover, the features of the above embodiment may be combined.

While the above embodiment relates to a case where the covering member 19 is employed in the disc brake device 10, the configuration of the above embodiment is also applicable to other devices in which the pleated covering member 19 defines a sealed space.

A related-art structure serving as a disc brake device is described in, for example, Japanese Unexamined Patent Application Publication (JP-A) No. H11-287267. In such a typical disc brake device described in JP-A No. H11-287267, pads are disposed on two respective sides of a rotor. One of the pads is fixed to a caliper body, and the other pad is allowed to be pushed by a piston. Furthermore, a slide pin is disposed with one end thereof fixed to the caliper body and the other end thereof placed in an insertion hole provided in a support bracket. A portion of the slide pin that is exposed outside the insertion hole is covered with a pleated cover. That is, the slide pin is accommodated in a closed space.

The disc brake device described in JP-A No. H11-287267 mentioned above has room for improvement from the viewpoint of reducing the resistance that occurs while the disc brake device is in operation.

When the disc brake device is activated while a vehicle including the disc brake device is traveling, the pads sandwich the rotor, which decelerates or stops the vehicle. However, when the rotor sandwiched by the pads is released, face runout in which the rotor runs out in the thickness direction thereof tends to occur because of factors such as the manufacturing tolerance of the rotor. In such a situation, the rotor pushes the pads and thus displaces the caliper body and the slide pin. The displacement changes the volume of the closed space in which the slide pin is accommodated, which increases the drag resistance occurring in the disc brake device and consequently reduces the energy efficiency of the vehicle during traveling.

In addition, since the disc brake device is a safety device that ensures safety during the travel of the vehicle, the configuration of the disc brake device is strictly regulated by relevant laws and ordinances of each country involved. Therefore, it is not easy to provide the disc brake device with a dedicated structure for reducing the drag resistance.

In view of the above, it is desirable to provide a disc brake device that exhibits a resistance reduced for improved energy efficiency of the vehicle during traveling.

An aspect of the disclosure provides a disc brake device including a rotor, a caliper body, a first pad, a second pad, a piston, a slide pin, a support bracket, and a covering member. The caliper body is disposed near the rotor. The first pad is disposed facing the rotor on a first side of the rotor and is fixed to the caliper body. The second pad is disposed facing the rotor on a second side of the rotor. The piston is configured to push the second pad toward the rotor. The slide pin is fixed to the caliper body. The support bracket has an insertion hole in which the slide pin is placed. The covering member has a pleat and covers a portion of the slide pin, the portion being exposed outside the insertion hole. A space defined by the insertion hole and the covering member that enclose the slide pin serves as an internal space. The internal space includes a first internal space and a second internal space. The first internal space is provided in the pleat of the covering member. The second internal space is obtained by excluding the first internal space from the internal space. A ratio of a first volume that is a volume of the first internal space to a second volume that is a volume of the second internal space is set within a predetermined range.

Obviously, numerous modifications and variations of the present invention are possible in light of the above teachings. It is therefore to be understood that within the scope of the appended claims, the invention may be practiced otherwise than as specifically described herein.

1. A disc brake device, comprising:
a rotor;
a caliper body;
a slide pin fixed to the caliper body;
a support bracket having an insertion hole configured to place the slide pin; and
a covering member having a pleat and covering a portion of the slide pin exposed outside the insertion hole of the support bracket;
a first pad fixed to the caliper body and positioned to face the rotor on a first side of the rotor;
a second pad positioned to face the rotor on a second side of the rotor; and
a piston configured to push the second pad toward the rotor,
wherein the insertion hole of the support bracket and the covering member enclosing the portion of the slide pin form an internal space such that the internal space includes a first internal space in the pleat of the covering member and a second internal space excluding the first internal space from the internal space and that a ratio of a first volume of the first internal space to a second volume of the second internal space is set within a predetermined range.

2. The disc brake device according to claim 1, wherein the insertion hole of the support bracket and the covering member enclosing the portion of the slide pin form the internal space such that the ratio of the first volume to the second volume is in a range of 0.8 to 1.2.

3. The disc brake device according to claim 1, wherein the insertion hole of the support bracket and the covering member enclosing the portion of the slide pin form the internal space such that the ratio of the first volume to the second volume is set within a range in a domain of a movable amount of the slide pin.
